(19) United States
(12) Patent Application Publication
(10) Pub. No.: US 2025/0282978 A1
(43) Pub. Date: Sep. 11, 2025

(54) ADHESIVE TAPE FOR HEAT-GENERATING BATTERY CELL

(71) Applicant: Timo LEERMANN, Wuppertal (DE)

(72) Inventor: Timo LEERMANN, Wuppertal (DE)

(21) Appl. No.: 19/062,562

(22) Filed: Feb. 25, 2025

(30) Foreign Application Priority Data
Mar. 11, 2024 (DE) 202024101176.7

(51) Int. Cl. C09J 5/02; C08K 3/04; C09J 7/20; C09J 9/00; C09J 133/04

(52) U.S. Cl. CPC C09J 5/02; C08K 3/04; C09J 7/20; C09J 9/00; C09J 133/04; C08K 2201/001; C09J 2301/124; C09J 2301/504; C09J 2433/00; C09J 2467/006

(57) ABSTRACT

A motor-vehicle heat-generating unit is carried by a support with an adhesive tape between the unit and the support. The tape has a core film substrate band having a face turned toward the unit and a face turned away from the unit and toward the support, a thermally conductive adhesive layer between one of the faces and the unit and adhesively securing the band to the unit, and etching on the other face in heat-conducting engagement with the support.

### FIELD OF THE INVENTION

The present invention relates to an adhesive tape. More particularly this invention concerns such a tape for use in a heat-generating part, for instance an energy cell of a battery.

### BACKGROUND OF THE INVENTION

Such a tape typically has a film substrate band and at least one layer of adhesive compound on one face of the film substrate band, and wherein the adhesive tape enables thermal contact between the unit and a support for holding and cooling the unit.

Nowadays, batteries or batteries are typically used in motor vehicles with hybrid drive or in vehicles driven solely by electrical power. For this purpose, such batteries are assembled from one or more cell stacks, which include a plurality of energy storage cells connected electrically in series and/or parallel. Such energy storage cells may be lithium-ion cells, for example.

In order to guarantee the safety, function, and durability of such energy storage cells, it is essential to operate them within a predefined temperature range. Among other things, this in turn requires the dissipation of heat that is produced during power output or charging, for example. In this way, critical temperatures can be avoided. In this context, the lost heat produced is typically dissipated via a fluid- or air-cooling system.

The support provided at this point for holding and cooling the unit and in particular the individual energy storage cell of a battery module then assumes more than just a supporting and holding function. Rather, the support also takes on a cooling function, for example by providing one or more cooling passages between the individual energy storage cells within the support. Then, a coolant may be pumped through the one or more cooling passages in order to dissipate heat. Against this background, one commonly adopted approach is also to resort to supports made of aluminum, in order to keep the weight of the motor vehicle low while at the same time ensuring the necessary heat dissipation from the energy storage cell in question, via the adhesive tape, the support and the cooling passage located therein, until it finally reaches the coolant flowing in the cooling passage.

The individual energy storage cells may be mounted for example mechanically on a flat section of the support with connecting means. The adhesive tape is also often interposed here, between the energy storage cell concerned and the support, providing thermal contact between the unit and the support for holding and cooling the unit. This is the approach adopted by the species-defining prior art according to DE 10 2012 218 082, for example.

In fact, in this context a double-sided adhesive film is used that is designed to be electrically insulating and has high thermal conductivity. In this situation, the double-faced adhesive film also performs the function of a “gap filler” so that any unevenness between the surface of the support on the one hand and the surface of the energy storage cell on the other hand can be simply smoothed out at least partially thereby.

US 2014/0322581 discusses a cell stack for a battery that includes one or more battery cells. In this case among other things, a terminal connection plate is implemented for the electrical coupling of the individual energy storage cells and a cooling plate is provided as part of the support. A gap filler is used to ensure galvanic separation and for better heat transfer between the terminal connection plate in question and the cooling plate, the gap filler being for example a heat-conducting gel.

The prior art has generally proven to be effective but still allows room for further improvements. The heat-generating unit and in particular the energy storage cell on the one hand and the support on the other are particularly important in terms of the flow of heat and heat dissipation. This applies not only with regard to the design of the support and any cooling passages for coolant located therein but also and in particular for the adhesive tape that ensures the essential thermal contact between the unit in question and the support.

### OBJECTS OF THE INVENTION

It is therefore an object of the present invention to provide an improved tape for use between a heat-generating unit or part and a support to which heat is to be transmitted.

Another object is the provision of such an improved tape for use between a heat-generating unit or part and a support to which heat is to be transmitted that overcomes the above-given disadvantages.

### SUMMARY OF THE INVENTION

In order to attain this object a species-related combination within the scope of the invention is characterized in that the face of the film substrate band with adhesive compound is stuck to the unit and the free etched surface thereof, optionally with a heat-conducting mass, is in thermal contact with the support, or vice versa.

The invention is based initially on the discovery that the adhesive tape between the heat-generating unit or energy storage cell on the one hand and the metallic support for holding and cooling the unit on the other hand can be optimized in terms of its thermal conductivity and improved with respect to the prior art. For this purpose, the free face of the substrate band, i.e. the surface facing outward and toward the support, is etched. To do this, the free face of the substrate band concerned may for example and advantageously be treated chemically. Use of an acetic acid, in particular trichloroacetic acid is recommended for such a chemical treatment.

In principle, however, the free face of the substrate band may also be provided with etching by physical means, for example with ion beams, electron or laser beams. In this situation, a plasma treatment is particularly preferred as this creates the desired roughening of the face of the substrate band similarly to a plasma coating. Moreover, of course both surfaces of the film substrate band can be processed with the described etching treatment, the adhesive compound subsequently being applied as an adhesive compound layer to one of the two etched surfaces.

In either case, in this way the face of the adhesive support band that is etched and facing the support undergoes significant roughening. As a consequence, first any separating forces between the film substrate band on the one hand and the adhesive compound layer on the other hand can be increased. This is true especially for the variant in which the adhesive compound layer is applied to the etched surface, which is to say the film substrate band is etched on both faces. In principle, though the etched free surface may also face the unit. In this opposite case, the adhesive tape is stuck to the support. Nevertheless, in general adhesion takes place with the unit.

In addition, the free and etched face of the substrate band directed toward the support ensures greater heat conduction from the energy storage cell to the support. In fact, for untreated film substrate bands made of plastic, for example, thermal conductivities are usually observed in the range of less than 1 W/mK. With the etching treatment and the at least one free etched face of the substrate band created in this way, the thermal conductivity can be increased by multiples to this value. Indeed, in this context within the scope of the present invention, thermal conductivities from 5 W/mK to as much as 10 W/mK are observed

According to the invention, plastics that have proven effective for use as the film substrate band are those that are manufactured on the basis of in particular thermoplastic plastics. For example, the film substrate band may be manufactured on a base of PA (polyamide), PU (polyurethane), PVC (polyvinyl chloride) film, and the like. In this regard, a PET (polyethylene terephthalate) base has proven to be particularly advantageous, because it provides the desired tear resistance and easy processing property and that the same time competitive pricing. Moreover, such PET films also offer high thermal resistance and can be furnished with the etched free surface particularly conveniently.

An adhesive compound that has proven particularly effective for use as the adhesive compound layer is an adhesive compound selected from the group of natural or synthetic rubber-based adhesive compounds, and in particular UV-crosslinkable polyacrylate adhesive compounds. In such conditions, it is then usual to work with an application weight of the adhesive compound layer on the film substrate band in a range from 15 g/m² to 200 g/m².

In order to further increase the thermal conductivity of the adhesive tape created in this way, it has been found to be effective if the adhesive compound layer contains a heat-conducting filler material. This may be for example graphite or a mineral-based filler material. In this context, it usually also necessary to ensure that the adhesive tape used does not undergo an increase in electrical conductivity as a result of any filler materials. Rather, the adhesive tape should still retain its electrically insulating and at the same time thermally conducting properties and transfer the lost heat that is produced while the unit is in operation particularly effectively to the support, which functions as a heat sink, as it were.

Regarding the film substrate band, as part of the adhesive tape it may be of single-ply or multiple-ply construction. In principle, it is also conceivable that the film substrate band may be constructed with an additional textile layer, i.e. for example a combination of a PET film with a nonwoven or a woven fabric (also made of PET) is used.

Additionally, the film substrate band may be equipped with flame retardant protection. Such flame retardant protection of the film substrate band may be provided for example in such a way that the film is produced from a thermoplastic polyurethane and at least one ester of phosphoric acid or of a phosphonic acid serves as the flame retardant. Such a design is known in principle, and reference is made to above-cited US 2014/0322581 for this purpose.

In order to improve the heat conduction from the heat-generating unit and for example from the energy storage cell as far as the holding and cooling support still further, the free etched face of the substrate band may be in thermal contact with the support with the interposition of a thermally conductive adhesive or a thermally conductive gel as the thermally conductive compound. In such a case, it has been found advantageous to use a gel with silicone or aluminum-oxide base, for example, as such a thermally conductive gel. The thermally conductive adhesive may be designed such that its adhesive compound (like that of the adhesive tape) is provided with a thermally conductive filler material with, for example, graphite or mineral base.

The film substrate band typically has a thickness from 5 Φm to 250 Φm. As explained previously, the adhesive compound is applied to the film substrate band with an application weight of the adhesive compound layer from 15 to 200 g/m². Due to the free etched surface and the thermal conductivity increased thereby, it is possible to achieve thermal conductivity values of at least 5 W/mK by this means alone. These values can then be increased further, to as much as 10 W/mK, if the adhesive compound layer is furnished with a thermally conductive filler material, and the free etched face of the substrate band is also brought into thermal contact with the support with interposition of the thermally conductive compound and in particular the silicone-based thermally conductive gel. These may be considered the essential advantages.

### BRIEF DESCRIPTION OF THE DRAWING

The above and other objects, features, and advantages will become more readily apparent from the following description, reference being made to the accompanying drawing in which:

FIG. 1 is a longitudinal section through the combination of the invention; and

FIG. 2 is a large-scale view of the tape according to the invention.

### SPECIFIC DESCRIPTION OF THE INVENTION

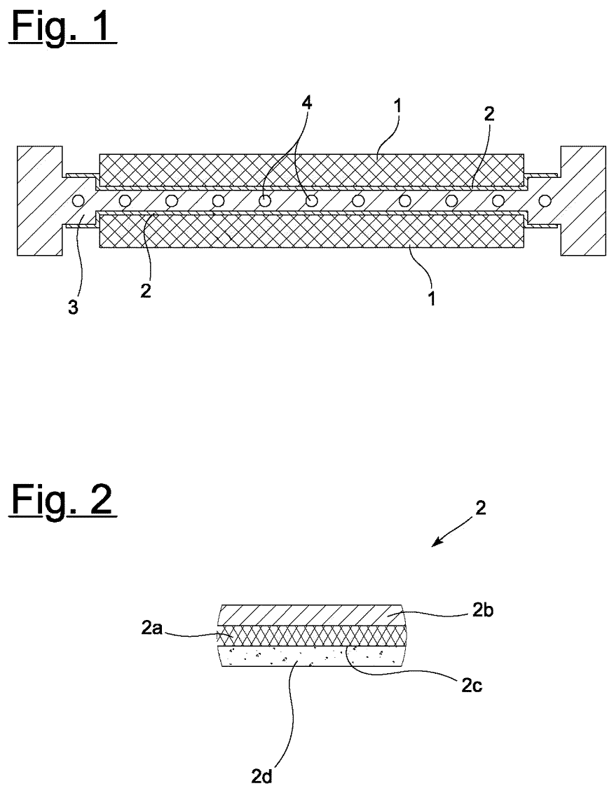

FIG. 1 shows a heat-generating unit 1 and an adhesive tape 2 in an unillustrated motor vehicle for the purpose of heat dissipation. Unit 1 for the purpose of this embodiment but without limitation thereto is an energy storage cell 1 of a battery represented schematically in part in FIG. 1. In fact, two energy storage cells 1 are represented here, arranged on either side of a central support 3.

For this purpose, the support 3 has with a bearing surface for the oppositely positioned energy storage cells 1. These bearing surfaces of the support 3 also have cooling passages 4 through which flows a coolant—not specified more precisely—for the purpose of heat dissipation.

According to this embodiment, the two oppositely positioned energy storage cells 1 are each connected thermally, and optionally mechanically as well, with interposition of the adhesive tape 2, to the support 3 and/or the bearing surface created here with the cooling passages 4. In any case, the adhesive tape 2 interposed between each energy storage cell 1 and the support 3 ensures that a thermal contact is assured between the unit or the respective energy storage cell 1 and the support 3 for holding and cooling the energy storage cell 1 in question.

For this purpose, the interposed adhesive tape 2 is constructed in detail as shown in the cross section of FIG. 2. It may be seen that the adhesive tape 2 has a film substrate band 2a. An adhesive compound layer 2b is applied to one face of the film substrate band 2a. According to this embodiment, the film substrate band 2a is designed as a PET film. The adhesive compound layer 2b is an adhesive compound layer made from a UV-crosslinkable acrylate adhesive. Of course, this only applies in the contest of this embodiment and is not to be considered limiting in any way.

The fact that the free face 2c of the film substrate band 2a is etched is also of essential significance. The film substrate band 2a according to this embodiment may also have been treated with and acetic acid, and in particular trichloroacetic acid, on both faces, with the result that both faces of the substrate band 2a have etchings. The adhesive compound layer 2b in the form of a UV-crosslinkable acrylate adhesive is then applied to one of these two faces. This can be carried out by applying this acrylate adhesive to the film substrate band 2a through a die in a hot-melt process.

As shown in the views of FIGS. 1 and 2, the free etched face 2c of the film substrate band 2a is now connected in thermally conductive manner to the support 3 with a thermally conductive compound 2d therebetween. In the context of this embodiment, the thermally conductive compound 2d is a thermally conductive adhesive or gel as described above. However, in principle this may also be dispensed with.

According to this embodiment, the film substrate band 2a is a single ply. However, in principle the invention also extends to film substrate bands 2a consisting of multiple plies. The further option, that the film substrate band 2a includes a flame retardant protection, as was also described previously, is not illustrated.

It may be seen that in the context of this embodiment the free etched face 2c of the film substrate band 2a is in thermal contact with the support 3 through the interposition of the thermally conductive gel 2d. In this situation, a thermally conductive adhesive may also be used instead of the thermally conductive gel 2d. In the context of this embodiment, the thermally conductive gel 2d is a silicone-based gel.

The film substrate band 2a itself has a thickness from 5 Φm to 250 Φm. The adhesive compound 2b is applied to the film substrate band 2a with an application weight of adhesive compound layer 2b in a range from 15 to 200 g/m². The further option, that the adhesive compound layer 2b is additionally furnished with a thermally conductive filler material such as graphite, in order to increase the overall thermal conductivity of the adhesive tape 2, is not illustrated. According to this embodiment, under these conditions, a thermal conductivity from 5 to 10 W/mK is observed.

A further object of the invention is the use of the adhesive tape 2 in a motor vehicle for the purpose of heat dissipation, where the adhesive tape 2 has the film substrate band 2a and at least the adhesive compound layer 2b on one face of the film substrate band 2a and the adhesive tape 2 conducts heat between the heat-generating unit 1 and the energy storage cell 1, for example, on the one hand, and the support 3 for holding the cooling the unit 1 on the other hand. For this purpose, the film substrate band 2a is stuck to the unit 1 on the adhesive compound face and is in thermal contact with the support 3 with its free, etched surface. The thermally conductive compound 2d may also be placed therebetween.

1. A combination comprising:
a motor-vehicle heat-generating unit;
a support adapted to carry the unit;
an adhesive tape between the unit and the support and including
a core film substrate band having a face turned toward the unit and a face turned away from the unit and toward the support,
a thermally conductive adhesive layer between one of the faces and the unit and adhesively securing the band to the unit, and
etching on the other face in heat-conducting engagement with the support.

2. The combination according to claim 1, wherein the etching is acetic-acid etching.

3. The combination according to claim 2, wherein the acetic acid is trichloroacetic acid.

4. The combination according to claim 1, wherein the adhesive layers is formed of a compound selected from the group of natural or synthetic rubber-based adhesive compounds.

5. The combination according to claim 4, wherein the compounds is a UV-crosslinkable polyacrylate adhesive compound.

6. The combination according to claim 1, wherein the adhesive layer is applied with an application weight from 15 to 200 g/m².

7. The combination according to claim 1, wherein the adhesive compound layer contains a thermally conductive filler material.

8. The combination according to claim 7, wherein the filler material is as graphite or a mineral.

9. The combination according to claim 1, wherein the film substrate band has a base of polyamide, polyurethane, or polyvinyl chloride.

10. The combination according to claim 9 wherein the base is polyethylene terephthalate.

11. The combination according to claim 1 wherein the film substrate band has one or more plies.

12. The combination according to claim 1, wherein the film substrate band contains a flame retardant.

13. The combination according to claim 1, further comprising:
a layer of thermally conductive adhesive or gel between the other face and the support.

14. The combination according to claim 13, wherein the adhesive or gel between the other face and the support is based on silicone or aluminum oxide.

15. The combination according to claim wherein the film substrate band has a thickness from 5 Φm to 250 Φm.

16. The combination according to claim 1, wherein the support is part of a cooler for the unit, whereby heat is drawn from the unit and taken up by the support for cooling the unit.
